(19) United States
(12) Patent Application Publication
(10) Pub. No.: US 2014/0315643 A1
(43) Pub. Date: Oct. 23, 2014

(54) SYSTEM AND METHOD FOR PLAYING FANTASY BASEBALL

(71) Applicant: JEREMY MUNTER, LOS ANGELES, CA (US)

(72) Inventor: JEREMY MUNTER, LOS ANGELES, CA (US)

(21) Appl. No.: 14/153,716

(22) Filed: Jan. 13, 2014

Related U.S. Application Data
(60) Provisional application No. 61/813,127, filed on Apr. 17, 2013.

(51) Int. Cl. A63F 13/30

(52) U.S. Cl. CPC A63F 13/12
USPC 463/42

(57) ABSTRACT

A method of playing a fantasy baseball game via a network server, comprising: establishing a fantasy baseball roster by a fantasy owner of professional baseball players; establishing a batting order for the fantasy baseball roster by the fantasy owner; and determining points generated by the batting order based on statistics generated by the professional baseball players in a professional baseball game.

### RELATED APPLICATIONS

This patent application is related to U.S. Provisional Application No. 61/813,127, filed Apr. 17, 2013, entitled “METHOD OF PLAYING FANTASY FOOTBALL” in the name of Jeremy Munter, and which is incorporated herein by reference in its entirety. The present patent application claims the benefit under 35 U.S.C. §119(e)

### TECHNICAL FIELD

This invention relates generally to fantasy sports, and, more particularly, to a method of playing fantasy baseball wherein a manager of the fantasy baseball team needs to strategize in order to determine where players should be positioned in the batting order to generate the most fantasy points.

### BACKGROUND

Fantasy sport leagues are an extremely popular activity. According to the Fantasy Sports Trade Association, in 2013 there were approximately 33,559,990 people playing fantasy sports in the United States. In Canada, there were approximately 3.1 million fantasy sports players in 2013. A fantasy sport is a game where participants act as owners to build a team that competes against other fantasy owners based on the statistics generated by the real individual players or teams of a professional sport. A fantasy league can be created for nearly any major professional sport, such as football (NFL), baseball (MLB), basketball (NBA), hockey (NHL), soccer (MLS) etc.

Players are traditionally selected in some form of a draft involving all of the fantasy owners. The fantasy owners can select any player in the league for their fantasy teams. Players can be selected independent of their real-life teams. In general, the fantasy game starts with a draft sometime before the start of the season. The draft can be done by various methods (e.g., snake draft or auction). In the draft, the fantasy owners pick players to fill up their rosters according to the fantasy league's roster settings.

The fantasy team scores points according to the real-life performance of the fantasy team's players. Probably the most common variant converts statistical performance into points that are compiled and totaled according to a roster selected by a manager that makes up a fantasy team. These point systems are typically simple enough to be manually calculated by a “league commissioner.” More complex variants use computer modeling of actual games based on statistical input generated by professional sports. In fantasy sports there is the ability to trade, cut, and sign players, like a real sports owner.

In fantasy sports, owners have had limited options in affecting their team's outcome. Currently the only strategic options available to an owner are related to managing the roster—including (1) which players are in the starting lineup, (2) which players to pick up from free agency and which players to drop from the team, and (3) which players to trade with other fantasy owners.

Therefore, it would be desirable to provide a system and method that overcomes the above problems by providing fantasy owners more options in team management.

### SUMMARY

A method of playing a fantasy baseball game via a network server, comprising: establishing a fantasy baseball roster by a fantasy owner of professional baseball players; establishing a batting order for the fantasy baseball roster by the fantasy owner; and determining points generated by the batting order based on statistics generated by the professional baseball players in a professional baseball game.

A method of playing a fantasy baseball game via a network server, comprising: establishing a fantasy baseball roster by a fantasy owner of professional baseball players; establishing a batting order for the fantasy baseball roster by the fantasy owner; establishing a plurality of fantasy baseball game rules to determine advancement of the fantasy baseball players around the bases; and determining points generated by the batting order based on statistics generated by the professional baseball players in a professional baseball game by comparing a current at bat position in the fantasy baseball game to a corresponding at bat in the professional baseball game to determining if a current player at bat on the fantasy baseball roster generates a run scored or Run Batted In (RBI) in the fantasy baseball game.

The foregoing and other objects, features, and advantages of the invention will be apparent from the following, more particular, description of the preferred embodiments of the invention, as illustrated in the accompanying drawings.

### BRIEF DESCRIPTION OF DRAWINGS

The novel features believed to be characteristic of the application are set forth in the appended claims. In the descriptions that follow, like parts are marked throughout the specification and drawings with the same numerals. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings:

FIG. 1 is a simplified block diagram of the system for implementing the fantasy baseball game of the present invention; and

FIG. 2 is a flow chart showing operation of the fantasy baseball game.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

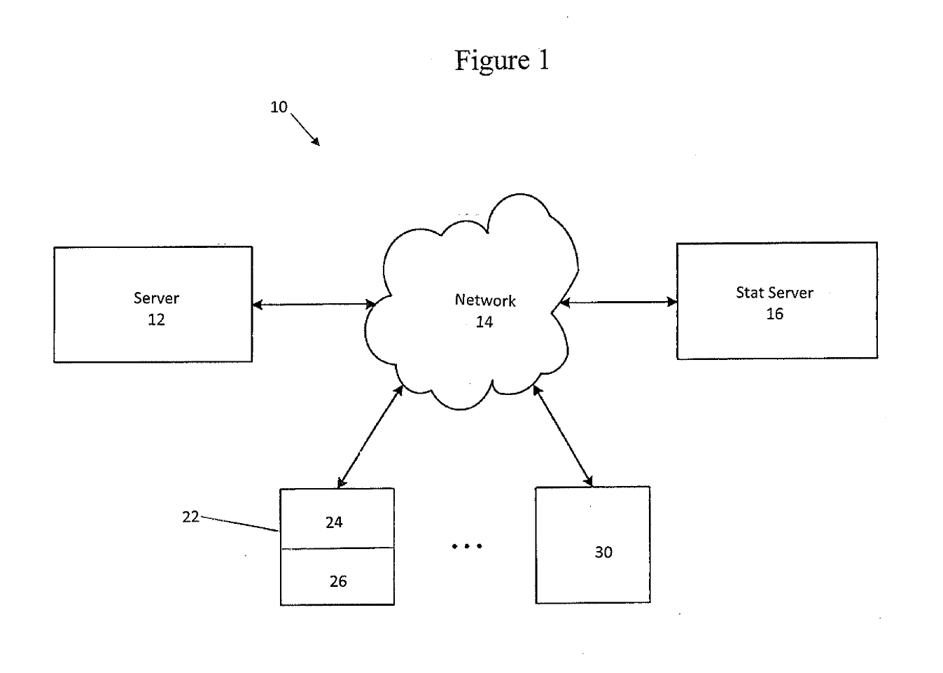

Referring to FIG. 1, a gaming system 10 for playing a fantasy sports league may be seen. The gaming system may use a computer network to connect a plurality of electronic devices for participating in a fantasy sports league. The gaming system 10 may have a server 12. The server 12 may have a processor and memory to carry out the processing of the game method of play through access by the various fantasy players.

Access may be carried out by means of a computer network 14. The computer network 14 may be a Local Area Network (LAN), Wide Area Network (WAN), Wireless Local Area Network (WLAN), or the like. The listing of the above computer networks 14 is given as an example and should not be seen in a limiting manner.

The server 12 may be coupled to a game statistics server 16. The game statistic server 16 may provide up to date game statistics from various professional sports leagues in order to calculate the points a fantasy team scores. The game statistics server 16 may be computer network 14.

The system 10 may have one or more computers 22. The computers 22 may be a desktop computer, laptop computer or the like. The computers 22 may either be a PC based computer or a Macintosh® based computer. The computers 22 may have an associate computer monitor 24 as well as a data input device 26. The computers 22 may allow the fantasy game players to sign in and participate in the fantasy sports league hosted on the server 12. The computer 22 may access the server 12 via the computer network 14. Other devices 30 may be used to access the server 12 to participate in the fantasy sports league hosted on the server 12. These devices 30 may include smart phone mobile devices, tablets and the like. The listing of the different types of devices 30 is given as an example and should not be seen in a limiting manner.

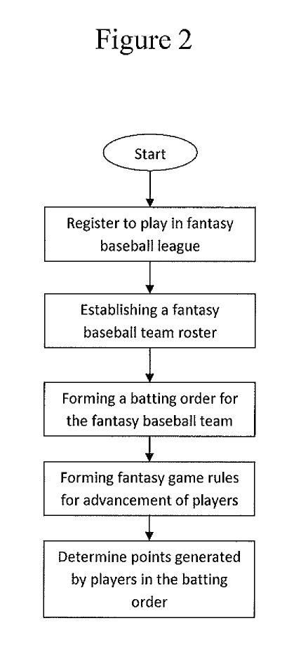

Referring now to FIG. 2, a method of playing a fantasy sports game is disclosed. Specifically, FIG. 2 discloses a method of playing a fantasy baseball game. Before the fantasy baseball game begins, a predefined number of people have to register to play. Once a sufficient number of people (hereinafter fantasy owner) have registered, a draft of players may be held. Players may be selected in some form of a draft involving all of the fantasy owners. The fantasy owners can select any player in the league for their fantasy teams. Players can be selected independent of their real-life teams. In general, the fantasy game starts with a draft sometime before the start of the season. The draft can be done by various methods (e.g., snake draft or auction). In the draft, the fantasy owners pick players to fill up their rosters according to the fantasy league's roster settings. The method of playing fantasy baseball may pertain to both seasonal and daily fantasy baseball leagues. The more attractive and more popular choice may be daily fantasy baseball salary cap format leagues, since you complete in leagues with multiple people who can all own the same player.

Once the roster of each fantasy owner is set, play may begin. Below, a description of a novel approach to scoring a fantasy baseball game which is batting order based. A unique aspect of a batting order based fantasy baseball game is that two fantasy owners may have the exact same team, but obtain different results (i.e., points scored) based on the batting order established by the fantasy owner. Thus, fantasy owners have to be more creative and employ more strategy than traditional fantasy baseball games.

The method of playing fantasy baseball of the present invention provides a different approach to real-time scoring. In this version if your team had a player, John Smith, and John Smith hits a home run, instead of everyone in the league who owns John Smith getting the same amount of points, the point determination may be based on John Smith's batting order position and what the batters do in front of John Smith. Thus, batting position order could have an advantage or disadvantage.

Thus, as an example, a fantasy owner may place John Smith as the fantasy owner's #1 Hitter. In an actual game, John Smith in his first At Bat (AB) hits a three run home run. Since John Smith was #1 in the fantasy owner's batting order, an nobody bats in front of #1 Hitter for his first AB, then John Smith would only earn the fantasy owner 1 home run and 1 Run Batted In (RBI) and not 3 RBIs as in current scoring methods.

The time of the day of each at-bat does not matter. If fantasy owner's #1 Hitter gets a single in his first at-bat at a 4:00 pm EST game, the #2 Hitter gets a single for his 1^{st} at Bat at a 5:00 pm EST game, and the #3 Hitter/#4 Hitter/#5 Hitter do not come up to bat until after a 10:00 pm EST game, then the fantasy owner will have to wait to see the results of those two base runners. As stated above, the fantasy owner's success for home runs/RBIs is determined by the performance of the fantasy owner's batting order.

For a runner positioned on second base, rules may be established so that the runner scores from second base on singles. Alternatively, rules may be established where runners only move one base at a time for a single and two bases for a double. Thus, if a runner is on second base and the next hitter on the fantasy owner's line-up hits a single, then the runner on second base would only advance one base to third base. Alternatively, or in addition to the above rule, the fantasy game may have the ability to label some players with a speed/power icon. This allows runners to advance an extra base on a hit. For example, if Billy Jones is designated with a speed icon, if Billy Jones is on first base and the next batter hits a single, Billy Jones would advance from 1^{st} to 3^{rd} base.

Another rule may be established for stolen bases. For stolen bases, a rule may be established that if a player steals a base with another runner in front of him already on that base, then the fantasy owner may have two players on the same base.

Another rule may be established for sacrifice flies/hits. For example, for any player on base, any fly ball hit to the outfield, the runners may advance one base. For any bunt, all runners may advance one base and the batter is ruled out. Alternatively, there may be no sacrifice fly rule and any player on base remains at that base for any fly ball.

For ground balls, a rule may also be established to determine if the ground ball results in a double play and two outs or a single out. For example, if there are one or more runners on base and there is a ground ball, the ground ball may result in a double play if there is a force out. If no force out is possible, for example the only runner on base is on second base, and there is a ground ball, then this would only count as a single out (i.e., the batter).

Another rule may be established if the number of actual at bats a player has during the actual game is less than that necessary to complete the fantasy game. Fr example, if a player only has a limited number of at bats, for example the player get hurts and only bats two times in a game, then the third time the player comes up in the order for the fantasy game, the player's at bat would be skipped and the next player goes to bat.

The above is a listing of potential rules that may be established for the fantasy baseball game. Other rules may be established without departing from the spirit and scope of the present invention. More specific rules may be established based on the details of the data received from the game statistic server 16. For example, a rule could be established where if there is a runner on 2^{nd} or 3^{rd} base, any ground ball to the right side of the infield allows the runners to advance one base while a ground ball to the left side holds the runner(s) at their respective base. By forming more specific rules, the fantasy baseball game more accurately emulate a real MLB game.

Below, an example will be shown on how a fantasy baseball game according to one embodiment of the present invention is played based on two teams playing with the same line-up but with each team having a different batting order for the players.

Like in a regular MLB game, each half inning last 3 outs and all players on base are removed after 3 outs. For the example below, the following rules are in place:

On a single from a hitter: Players advance 1 base at a time, thus, a runner on 1^{st} base goes to 2^{nd} base when the batter hits a single; a runner on 2^{nd} base goes to 3^{rd} base when the batter hits a single, alternatively, as stated above, a runner scores from 2^{nd} base on a single if the player is labeled as a speed player; and a runner on 3^{rd} base scores when the batter hits a single. The original batter ends up on 1^{st} base.

On a double from the batter: Players advance 2 bases at a time. Thus, a runner on 1^{st} base goes to 3^{rd} base when the batter hits a double and a runner on 2^{nd} base scores when the batter hits a double. The original batter ends up on 2^{nd} base.

On a triple from the batter: Players advance 3 based at a time. Thus, runners on 1^{st}/2^{nd}/3^{rd} base automatically score on a triple. The original batter ends up on 3^{rd} base.

For a home run: All runner score.

When a player steals a base: The runner advances one base. If two runners are on the same base, that is allowed in this format.

When a player gets out: An out is recorded for your team. Three outs and your team Reset the bases, like a real Baseball Game.

Furthermore, depending on the player's ability, some players may have certain icons that give them an advantage. In accordance with one embodiment, fantasy owner may have to pay for the icons.

### Example A

Chris Davis who has 40 Home Runs on the season and may have a Power Icon next to his name. RESULT A: Every time Chris Davis gets an Out that is not a strikeout, all players advance a base assuming he hit a fly ball to the outfield and did not ground out.

### Example B

Jacoby Ellsbury has 50 Stolen Bases on the season and may have a Speed Icon next to his name. RESULT B: Every time Jacoby Ellsbury is on base, he advances two bases on a hit. Meaning if he was on 1^{st} Base, and a player gets a single, he advances to 1^{d} Base. If he was on 2^{nd} Base and a player gets a single, he advances home.

Thus, as stats become more in-depth, the more in-depth the game becomes. Example, if they start recording where the out was as a Stat. Then the game can change based on these rules.

Scoring may be as follows, where the fantasy team that scores the most points wins:

### Option 1—Points Based Scoring

*Points per category can change*
1B=2 Points
2B=4 Points
3B=6 Points
HR=9 Points
RBI=3 Points
R=3 Points
SB=3 Points
BB=1 Point
HBP=1 Point
K=0.5 Points

Option 2—Real Simulation. In this option, the fantasy team scores as many runs as they possibly can. Each run is worth 1 Point. Once a total run count is obtained, the fantasy team's score is reduced by the pitcher's earned runs allowed. For example, the fantasy team scores 9 runs and the starting pitcher allows 4 runs/nine innings, the result is 9 (Runs scored)−4 (Runs Allowed)=5 Points.

In the example below Team A has selected a roster and will have the following Major League Baseball (MLB) players playing in the fantasy baseball game:

### Roster

C: CARLOS SANTANA—CLE
1B: PRINCE FIELDER—DET
2B: ROBINSON CANO—NYY
3B: EVAN LONGORIA—TB
SS: IAN DESMOND—WAS
OF: CARLOS BELTRAN—STL
OF: MIKE TROUT—LAA
OF: GIANCARLO STANTON—MIA
DH: ADAM JONES—BAL
1 Starting Pitchers
1 RELIEF PITCHER

Team A will place these players in a batting order. The fantasy owner may set the players in any batting order. The players do not have to bat in the order the player is actually batting in the MLB game. For example, if Robinson Cano is actually batting 3^{rd} for the New York Yankees in the actual MLB game, the fantasy owner may place Robinson Cano at any place in the batting order where the fantasy owner thinks it will strategically benefit the fantasy owner. Further, the fantasy owner does not have to depend on the New York Yankees to get players on base for Robinson Cano, or players to hit him home when he is on base as this now may be based on the players the fantasy owner selects and positions on the batting order.

The fantasy owner may enter the following batting order:
Robinson Cano
Adam Jones
Mike Trout
Ian Desmond
Evan Longoria
Carlos Santana
Prince Fielder
Giancarlo Stanton
Carlos Betlran

Each of the above players have the following statistics for the day based on their MLB games that they played:
MIKE TROUT (LAA)—OF—(10:00 pm EST)|1B|Ground Out|2B|1B/SB|Pop Out
GIANCARLO STANTON (MIA)—OF—(7:00 pm EST)|Pop Out|HR|2B|Pop Out
CARLOS BELTRAN (STL)—OF—(8:00 pm EST)|2B|2B|Strike Out|HR|Single
EVAN LONGORIA (TB)—3B—(8:00 pm EST)|1B|HR|Pop Out|Single|Ground Out
IAN DESMOND (WAS)—SS—(7:00 pm EST)|1B|1B|Strike Out|Single
ROBINSON CANO (NYY)—2B—(7:00 pm EST)|1B|HR|HR|Single|HR|2B|1B
PRINCE FIELDER (DET)—1B—(8:00 pm EST)|1B|Pop Out|Strike Out
CARLOS SANTANA (CLE)—C (8:00 pm EST)|HR|Ground Out|1B|2B
ADAM JONES (BAL)—DH—(7:00 pm EST)|1B/SB|1B/CS|2B|Sacrifice

Based on the above and Team A's batting order, Team A performs as follows:

ROBINSON CANO (NYY)—2B—(7:00 pm EST)|1B|HR|HR|Single|HR|2B|1B

EVAN LONGORIA (TB)—3B—(8:00 pm EST)|1B|HR|Pop Out|Single|Ground Out

CARLOS SANTANA (CLE)—C (8:00 pm EST)|HR|Ground Out|1B|2B

PRINCE FIELDER (DET)—1B—(8:00 pm EST)|1B|Pop Out|Strike Out

CARLOS BELTRAN (STL)—OF—(8:00 pm EST)|2B|2B|Strike Out|HR|Single

MIKE TROUT (LAA)—OF—(10:00 pm EST)|1B|Ground Out|2B|1B/SB|Pop Out

IAN DESMOND (WAS)—SS—(7:00 pm EST)|1B|1B|Strike Out|Single

ADAM JONES (BAL)—DH—(7:00 pm EST)|1B/SB|1B/CS|2B|Sacrifice

GIANCARLO STANTON (MIA)—OF—(7:00 pm EST)|Pop Out|HR|2B|Pop Out

For a 5 inning fantasy baseball game, the above line up and batting order for Team A may score as follows:

### 1^{st} INN

Cano is on 1^{st} Base with a single. Evan Longoria gets a single. Cano advances to 2^{nd}. Carlos Santana Hits a HR. Cano and Longoria Score. Thus, Team A scores 1 HR/3 RBI/3 Runs. Depending on the scoring system, the user can get points for each HR/RBI/Runs or 3 Runs may be added to score.

Prince Fielder gets a single. Carlos Beltran Hits a Double. Fielder advances to 3^{rd} Base. Mike Trout gets a Single. Fielder scores, Beltran Scores. Team A scores 1 HR/5 RBI/5 Runs. All Runners score from 2^{nd} Base On a Single. Some Games may allow you to give certain players speed icons. They can advance an extra base on every hit.

Mike Trout is one 1^{st} base. Ian Desmond Gets a Single. Trout advances to 2^{nd} Base. If he had the icon he would 3rd advance to Base. Runners on 1^{st} and 2^{nd}. Adam Jones gets a single. Runner from 2^{nd} Base Scores, Trout. Desmond advances to 2^{nd} Base. Team A now has 1 HR/6 RBI/6 Runs.

Adam Jones Steals a Base. Both him and Desmond are on 2^{nd} Base. Giancarlo Stanton pop outs. Now there is 1 out and runners on 2^{nd} base. Robinson Cano hits a HR in his 2^{nd} At Bat. Since he is due up in your order, you get that result. Cano adds to your totals which are now at 2 HR/9 RBI/9 Runs. Since all runners score. Evan Longoria comes up to bat. He Hits a HR. Team A now has 3 HR/10 RBI/10 Runs. Carlos Santana comes up and ground out for a 2^{nd} out. Prince Fielder comes up. He Pops Out and the INN is over. Total for the 1^{st} inning for Team A is 10 Runs/10 RBIs/3 HR.

Bases are clear and the 2^{nd} INN begins with Beltran

### 2^{ND} INN

Carlos Beltran comes up. He Hits a Double. It should be noted that most fantasy sites will still give points for all hits. A double may be worth 2 Points if a Single is worth 1. Next Batter is Mike Trout. He grounds out. Some fantasy sites may want the runner to advance on the ground out. For this example it will not show that, but it could be an option. 1 OUT. Carlos Beltran on 2^{nd} Base.

Next Batter is Ian Desmond. He Gets a single. Carlos Beltran Score. Team A has 3 HR/11 RBI/11 Runs. Desmond is on 1B. Adam Jones gets a Single. Desmond advances to 2^{nd} Base. Then Adam Jones is Caught Stealing. Desmond stays on 2^{nd} Base. There are now 2 Outs. Giancarlo Stanton hits a HR. Desmond scores. Team A has 4 HR/13 RBI/13 Runs. Then Robinson Cano comes up for a 3^{rd} Time. He hits a HR. Nobody on base. Team A has 5 HR/14 RBI/14 Runs.

Evan Longoria then pops out, which is the 3^{rd} out of the INN. Runners are cleared. Order resumes at #3 in the batting order.

### 3^{rd} INN

Carlos Santana starts off the INN with a single. Santana is on 1B. Then, Prince Fielder Strikes Out. Runner on 1st/1 Out.

Carlos Beltran Strikes out right after. Runner on 1^{st}/2 Outs. Mike Trout hits a Double. Santana is on 3^{rd} Base. Trout on 2^{nd}. 2 Outs. Ian Desmond strikes Out. Ends the INN. Bases Cleared. Team A total remains 5 HR/14 RBI/14 Runs.

### 4^{th} INN

Adam Jones starts the INN off with a 2B. Since that is what he did in his 3^{rd} at bat. Jones on 2B. 0 out. Giancarlo Stanton hits a Double in his 3^{rd} at bat. Jones Scores. Stanton on 2B. 5 HR/15 RBI/15 Runs. Robinson Cano gets a Single in his 4^{th} at-bat. Stanton Scores. 5 HR/16 RBI/16 Runs. Evan Longoria gets a Single. Cano Advances to 2^{nd} Base. Longoria is at 1B. Since Prince Fielder never received a 4^{th} At-Bat in his game, his day is over and his spot in the batting order is now skipped for the rest of the night. Carlos Beltran comes up. He Hits a Home Run. Cano and Longoria score as well as Beltran. Team A score 6 HR/19 RBI/19 Runs.

Trout then gets a Single. Later he steals a base. Before Desmond's at-bat is accorded, Trout does get the SB. Ian Desmond gets a Single. Trout scores from 2^{nd} Base. Team A score 6 HR/20 RBI/20 Runs.

Adam Jones gets a sacrifice in his game, real-time. Desmond advances to 2^{nd} Base. 1 Out is recorded. Giancarlo Stanton Pops out. Desmond stays at 2^{nd} Base. 2 Outs. Robinson Cano comes up. Hits another HR in his 5^{th} At-Bat. Desmond scores. Team A score 7 HR/22 RBI/22 Runs. Longoria grounds out. INN over.

### 5^{th} INN

Since Santana and Fielder did not get 5^{th} At-Bats the order skips to Beltran. Beltran gets a single in his 5^{th} AB of the night. Trout Pops out. Beltran stays at 1B. 1 Out. Desmond/Jones/Stanton only got 4 Abs. So their night is over. Lineups moves forward to Cano and his 6^{th} At-Bat. Robinson Cano hits a Double. Beltran advances to 3^{rd} Base. Cano is on 2^{nd} Base. 1 Out. Since nobody else got a 6^{th} At-Bat besides Cano. The lineup fasts forward to the next batter which is Cano and his 7^{th} At-Bat. Cano gets a Single. Beltran Scores. Cano Scores his 6^{th}-At Bat from 2B. Team A score HR/22 RBI/22 Runs is the Final Line for This Team.

Fantasy Sites may give points for Singles/Doubles/Triples/HR/SB/CS, but they cannot play this style of play with a simulated lineup unless they go through me.

TEAM B has the same roster but has a batting order as follows:

MIKE TROUT (LAA)—OF—(10:00 pm EST)|1B|Ground Out|2B|1B/SB|Pop Out

CARLOS BELTRAN (STL)—OF—(8:00 pm EST)|2B|2B|Strike Out|HR|Single

PRINCE FIELDER (DET)—1B—(8:00 pm EST)|1B|Pop Out|Strike Out

ROBINSON CANO (NYY)—2B—(7:00 pm EST)|1B|HR|HR|Single|HR|2B|1B

EVAN LONGORIA (TB)—3B—(8:00 pm EST)|1B|HR|Pop Out|Single|Ground Out

GIANCARLO STANTON (MIA)—OF—(7:00 pm EST)|Pop Out|HR|2B|Pop Out

ADAM JONES (BAL)—DH—(7:00 pm EST)|1B/SB|1B/CS|2B|Sacrifice

IAN DESMOND (WAS)—SS—(7:00 pm EST)|1B|1B|Strike Out|Single

CARLOS SANTANA (CLE)—C (8:00 pm EST)|HR|Ground Out|1B|2B

### 1st INN

Mike Trout gets a Single. Trout on 1^{st}. Zero Outs. Carlos Beltran Gets a Double. Trout on 3^{rd}. Beltran on 2^{nd}. Zero Outs. Prince Fielder gets a Single. Trout and Beltran Score. Team B score 0 HR/2 RBI/2 Runs.

Robinson Cano gets a Single. Fielder goes to 2^{nd} Base. Evan Longoria gets a Single. Fielder Scores. Cano advances to 2^{nd} Base. Team B score 0 HR/3 RBI/3 Runs. Zero Outs.

Stanton Pops Out. 1 Out. Adam Jones gets a Single. Cano Scores. Longoria Advances to 2^{nd} Base. 1 Out. Tem B score 0 HR/4 RBI/4 Runs.

Adam Jones Steals 2^{nd} Base. Jones is on 2^{nd} Base with Longoria. Ian Desmond gets a Single. Both Jones and Longoria Score. Team B score 0 HR/6 RBI/6 Runs. 1 Out. Carlos Santana hits a HR. Team B score 1 HR/7 RBI/7 Runs. Mike Trout Grounds Out. 2 Outs. Carlos Beltran gets a Double. Beltran on 2^{nd}. 2 Outs. Prince Fielder Pops Out. 1^{st} INN over. Runners cleared. Team B score 1 HR/7 RBI/7 Runs.

### 2^{nd} INN

Robinson Cano starts the INN. He hits a HR. Team B score 2 HR/8 RBI/8 Runs. Evan Longoria comes up. He hits a HR. Team B score 3 HR/9 RBI/9 Runs. Giancarlo Stanton Comes up. He Hits a HR. Team B score 4 HR/10 RBI/10 Runs. Adam Jones comes up, hits a Single. He then is Caught Stealing later on. 1 Out. Ian Desmond comes up, he hits a Single. Runner on 1^{st}, 1 Out. Carlos Santana comes up, he grounds out, 2 Outs. Trout comes up for the 3^{rd} Time. Trout hits a 2B. Trout on 2^{nd}. Ian Desmond on 3^{rd} base. Carlos Beltran Strikes Out for the 3^{rd} out. Team B score 3 HR/8 RBI/8 Runs.

### 3^{rd} INN

Prince Fielder Strikes out. 1 Out. Robinson Cano hits a HR. Team B score 4 HR/9 RBI/9 Runs. Evan Longoria Pops Out. 2 Out. Giancarlo Stanton hits a 2B. Stanton on 2B. 2 out. Adam Jones hits a 2B and Stanton scores. Team B score 4 HR/10 RBI/10 Runs. Ian Desmond Strikes Out in his 3^{rd} At-Bat. 3 Outs.

### 4^{th} INN

Carlos Santana gets a Single in his 3^{rd} At-Bat. Mike Trout comes up for his 4^{th} At-Bat. Trout gets a Single. Santana advances to 2B. Trout Steals 2^{nd} Base. Santana and Trout on 2^{nd} Base. Carlos Beltran Comes up, hits a HR. Team B score 5 HR/13 RBI/13 Runs. Prince Fielder is skipped since he did not get a 4^{th} at Bat.

Lineup goes to Cano who gets a Single. Cano on 1B. Longoria gets a Single. Cano to 2B. Stanton pops out. 1 out. Adam Jones gets a sacrifice. 2 outs. Longoria on 2B and Cano on 3B base. Ian Desmond gets a single. Cano scores and Longoria goes to 3B. Team B score 5 HR/14 RBI/14 Runs. Carlos Santana gets a 2B. Trout scores and Desmond goes to 3B. Team B score 5 HR/15 RBI/15 Runs. Mike Trout pop outs. 3 outs. Team B score 5 HR/14 RBI/14 Runs.

### 5^{th} INN

Beltran, nor Fielder got to a 5^{th} At-Bat. Lineup skips to Cano. Cano hits a HR. 6 HR/15 RBI/15 Runs. Cano comes up again. Since nobody else has 5 At-Bats. Cano in his 6^{th} At-Bat gets a Double. Cano in his 7^{th} At-Bat gets a Single, scoring the double he just got. 5 HR/15 RBI/15 Runs is the Team Final Line.

Scores may vary based on the rules implemented but the above is an example of how the game is ran. As can be seen from the above, even though both team had the same players, the score caries by the position of the players in the batting order.

In accordance with one embodiment of the present invention, each team may select one starting pitcher and one relief pitcher. Scoring can work in a variety of ways. In accordance with one embodiment, pitchers can get points for each statistic they achieve in real time. For example, Clayton Kershaw's statistics for the MLB game are: 7 INNINGS/3 EARNED RUNS/6 STRIKE OUTS/1 Walk and earns a win. A fantasy team may be awarded additional points as follows:

### SCORING

INN PITCH=1 Point
EARNED RUN=−1 Point
STRIKE OUT=5 Points.
BALL=−1 Point.
WIN=6 Points.
SAVE=4 Points.
LOSS=−2 Points.

In this example Kershaw would get 6+(7×1)+(3×−1)+(6×5)+(1×−1)=3=39 Points.

The same scoring may be done for the relief pitcher. However, some relief pitchers may not even pitch an inning.

Pitching scoring may be done in other ways as well. For example, if the game is offensive runs your team Scores VS. how many Earned Runs your pitcher allows, then for every Run your Pitcher allows. −1 will be taken away from your total offensive Runs. So in the example above with the batting orders. If Kershaw allows 3 Earned Runs, then if Team 1 Scored Runs because of their offense, Team 1 would lose 3 Runs because Kershaw allowed them. If your relief pitcher comes in and allows an earned run, the Team 1 would lose another run.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of playing a fantasy baseball game via a network server, comprising:
establishing a fantasy baseball roster by a fantasy owner of professional baseball players;
establishing a batting order for the fantasy baseball roster by the fantasy owner; and
determining points generated by the batting order based on statistics generated by the professional baseball players in a professional baseball game.

2. The method of claim 1, wherein determining points generated by the batting order further comprises comparing a current at bat position in the fantasy baseball game to a corresponding at bat in the professional baseball game to determining if a current player at bat on the fantasy baseball roster generates a run scored or Run Batted In (RBI) in the fantasy baseball game.

3. The method of claim 1, wherein determining points generated by the batting order further comprises determining if a current at bat of a fantasy baseball player results in a previous at bat fantasy baseball player scores a run based on a corresponding at bat in the professional baseball game.

4. The method of claim 1, further comprising establishing a plurality of fantasy baseball game rules to determine advancement of the fantasy baseball players around the bases.

5. The method of claim 4, wherein at least one fantasy baseball game rule is that all fantasy baseball players on base advance one base when a successive fantasy baseball player at bat records a single in a corresponding at bat in a professional baseball game.

6. The method of claim 4, wherein at least one fantasy baseball game rule is that all fantasy baseball players on base advance two bases when a successive fantasy baseball player at bat records a double in a corresponding at bat in a professional baseball game.

7. The method of claim 4, wherein at least one fantasy baseball game rule is that all fantasy baseball players on base advance one base when a successive fantasy baseball player at bat records an outfield fly out in a corresponding at bat in a professional baseball game.

8. The method of claim 1, further comprising marking a player as a speed player, wherein the speed player advances two bases when a successive fantasy baseball player at bat records a single in a corresponding at bat in a professional baseball game.

9. The method of claim 1, further comprising marking a player as a power player, wherein the power player allows any fantasy baseball player on base to advance one base when the power player at bat records an outfield fly out in a corresponding at bat in a professional baseball game.

10. The method of claim 1, further comprising subtracting points for runs allowed by a pitcher on the fantasy baseball roster from the points generated by the batting order.

11. A method of playing a fantasy baseball game via a network server, comprising:
establishing a fantasy baseball roster by a fantasy owner of professional baseball players;
establishing a batting order for the fantasy baseball roster by the fantasy owner;
establishing a plurality of fantasy baseball game rules to determine advancement of the fantasy baseball players around the bases; and
determining points generated by the batting order based on statistics generated by the professional baseball players in a professional baseball game by comparing a current at bat position in the fantasy baseball game to a corresponding at bat in the professional baseball game to determining if a current player at bat on the fantasy baseball roster generates a run scored or Run Batted In (RBI) in the fantasy baseball game.

12. The method of claim 11, wherein determining points generated by the batting order further comprises determining if a current at bat of a fantasy baseball player results in a previous at bat fantasy baseball player scores a run based on a corresponding at bat in the professional baseball game.

13. The method of claim 11, wherein at least one fantasy baseball game rule is that all fantasy baseball players on base advance one base when a successive fantasy baseball player at bat records a single in a corresponding at bat in a professional baseball game.

14. The method of claim 11, wherein at least one fantasy baseball game rule is that all fantasy baseball players on base advance two bases when a successive fantasy baseball player at bat records a double in a corresponding at bat in a professional baseball game.

15. The method of claim 11, wherein at least one fantasy baseball game rule is that all fantasy baseball players on base advance one base when a successive fantasy baseball player at bat records an outfield fly out in a corresponding at bat in a professional baseball game.

16. The method of claim 11, further comprising marking a player as a speed player, wherein the speed player advances two bases when a successive fantasy baseball player at bat records a single in a corresponding at bat in a professional baseball game.

17. The method of claim 11, further comprising marking a player as a power player, wherein the power player allows any fantasy baseball player on base to advance one base when the power player at bat records an outfield fly out in a corresponding at bat in a professional baseball game.

18. The method of claim 11, further comprising subtracting points for runs allowed by a pitcher on the fantasy baseball roster from the points generated by the batting order.
